(19) United States
(12) Patent Application Publication
(10) Pub. No.: US 2009/0235234 A1
(43) Pub. Date: Sep. 17, 2009

(54) DETERMINING MINIMAL SETS OF BUGS SOLUTIONS FOR A COMPUTER PROGRAM

(76) Inventors: Marina Biberstein, Qiryat Mozkin (IL); Shay Bushinsky, Ganei Tikva (IL); Eitan Farchi, Pardes Hanna (IL); Shmuel Ur, Misgav (IL)

Correspondence Address: IBM CORPORATION, T.J. WATSON RESEARCH CENTER, P.O. BOX 218, YORKTOWN HEIGHTS, NY, 10598, US

(21) Appl. No.: 12/049,334

(22) Filed: Mar. 16, 2008

(51) Int. Cl. G06F 9/44

(52) U.S. Cl. 717/124

(57) ABSTRACT

A system for automated bug detection and solution including a testing tool operative to record execution behavior and output of a computer program, and a determiner including a bug pattern detector operative to analyze the program execution behavior and output to identify a bug pattern therein and propose at least one program modification for effecting a solution to eliminate the bug pattern, a solution query & search module operative to iteratively define a plurality of subsets of the proposed solutions in accordance with a predefined selection criterion, and a bug solution inserter operative to iteratively apply the subsets of proposed solutions to the program.

### FIELD OF THE INVENTION

The present invention relates to computer programming and testing in general, and in particular to determining minimal sets of bug solutions therefor.

### BACKGROUND OF THE INVENTION

Computer programs, such as multi-threaded programs, typically run in a computer environment where the Operating System (OS), such as Microsoft Windows®, and possibly a runtime environment as well, such as the Java® Virtual Machine® (JVM), control one or more executable program threads, where an executable program is associated with a thread at a particular time. In addition, each executable program may access a shared resource, such as shared memory.

The interactions between the OS, threads, executable program and shared resource may produce chaotic behavior. This is primarily due to the complexity of the computer environment and the effect that small perturbations may have on the executable program's results. These perturbations have numerous causes and manifestations, most notably related to the timing of executed program instructions, and often result in intermittent execution errors that may be traced back to a programming error or “bug.”

In addition to using manual techniques to detect programming errors, automated bug detection tools may be used. While existing bug detection tools provide information regarding the performance and validity of typical computer programs, increasingly complex programs have created a need for more sophisticated bug detection techniques. This is particularly true with regard to multi-threaded computer programs where program execution errors may be caused by environmental factors that that may make bugs more elusive.

### SUMMARY OF THE INVENTION

The present invention discloses a system and method for determining a solution set for bugs found in computer programs, such as a multi-threaded computer programs. In the present invention a computer program P is defined to have a bug B when the execution of P produces a result R that does not satisfy requirements Q. For example, a multi-threaded program having 10 threads, each incrementing a shared zero-initialized variable in an unsynchronized manner, may be expected during bug-free execution to produce a result of 10. However, due to a bug that occurs under certain circumstances, such as when the program is executed under the influence of an automated testing tool, the result of the program is 5. In this example the program P is an accumulator, the result R is 5, while the requirements for successful execution Q is 10.

One or more bug patterns are identified in P from a set of predefined bug patterns, and a solution space is defined that includes a set of candidate solutions for eliminating bug B. These solutions may include modifications to P, such as protecting shared variables with synchronization points. Furthermore, a single candidate solution may include multiple types of modifications to P, such as modifying synchronization points and replacing shared variables with local variables. The solution space of candidate solutions is then searched to determine a minimal set of solutions that will eliminate bug B.

In one aspect of the present invention a system is provided for automated bug detection and solution including a testing tool operative to record execution behavior and output of a computer program, and a determiner including a bug pattern detector operative to analyze the program execution behavior and output to identify a bug pattern therein and propose at least one program modification for effecting a solution to eliminate the bug pattern, a solution query & search module operative to iteratively define a plurality of subsets of the proposed solutions in accordance with a predefined selection criterion, and a bug solution inserter operative to iteratively apply the subsets of proposed solutions to the program.

In another aspect of the present invention the testing tool is operative to introduce perturbations into the program.

In another aspect of the present invention the bug pattern is predefined.

In another aspect of the present invention the solution is in predefined association with the predefined bug pattern.

In another aspect of the present invention the solution query & search module is operative to identify any of the solution subsets that satisfies a predefined solution criterion.

In another aspect of the present invention the predefined solution criterion is whether any of the subsets has the fewest members among all of the subsets that together eliminate the bug pattern.

In another aspect of the present invention the predefined solution criterion is whether, after a predefined number of iterations, any of the subsets that have been applied to the program has the fewest members among all of the subsets that together eliminate the bug pattern.

In another aspect of the present invention the predefined solution criterion is whether any of the subsets has a member population smaller than a predefined size that together eliminate the bug pattern.

In another aspect of the present invention a method is provided for determining a required solution subset from a set of solutions for computer program execution errors, the method including a) selecting a first candidate solution subset from a set of solutions, b) applying the first candidate solution subset to a computer program, thereby creating a first version of the program, c) selecting a second candidate solution subset from the set of solutions, d) applying the second candidate solution subset to the program, thereby creating a second version of the program, e) adding the difference between the first and second candidate solution subsets to a required solution subset where one of the program versions satisfies a predefined set of requirements, and the other of the program versions does not satisfy the predefined set of requirements, and f) performing steps a)-e) a plurality of times for different candidate solution subsets until the required solution subset satisfies the predefined set of requirements.

In another aspect of the present invention the adding step includes adding where the populations of the candidate solution subsets differ by one member.

In another aspect of the present invention the performing step includes performing until the application of the required solution subset to the program eliminates a predefined set of execution errors when the program is executed.

In another aspect of the present invention a method is provided for determining a solution subset from a set of solutions, the method including a) selecting a first candidate solution subset from a set of solutions, b) selecting a second candidate solution subset from the set of solutions, c) adding the difference between the first and second candidate solution subsets to a required solution subset where one of the candidate solution subsets satisfies a predefined set of requirements, and the other of the candidate solution subsets does not satisfy the predefined set of requirements, and d) performing steps a)-c) a plurality of times for different candidate solution subsets until the required solution subset satisfies the predefined set of requirements.

In another aspect of the present invention the adding step includes adding where the populations of the candidate solution subsets differ by one member.

In another aspect of the present invention a computer program is provided embodied on a computer-readable medium, the computer program including a first code segment operative to select a first candidate solution subset from a set of solutions, a second code segment operative to applying the first candidate solution subset to a computer program, thereby creating a first version of the program, a third code segment operative to selecting a second candidate solution subset from the set of solutions, a fourth code segment operative to applying the second candidate solution subset to the program, thereby creating a second version of the program, and a fifth code segment operative to adding the difference between the first and second candidate solution subsets to a required solution subset where one of the program versions satisfies a predefined set of requirements, and the other of the program versions does not satisfy the predefined set of requirements, where any of the code segments may be executed a plurality of times for different candidate solution subsets until the required solution subset satisfies the predefined set of requirements.

### BRIEF DESCRIPTION OF THE DRAWINGS

The present invention will be understood and appreciated more fully from the following detailed description taken in conjunction with the appended drawings in which:

FIG. 1 is a simplified illustration of a program execution environment, useful in understanding the present invention;

FIG. 2 is a simplified illustration of a program testing environment, useful in understanding the present invention;

FIG. 3 is a simplified illustration of an automated bug detection and solution environment, constructed and operative in accordance with a preferred embodiment of the present invention;

FIG. 4 is a simplified illustration of selected elements of FIG. 3, constructed and operative in accordance with a preferred embodiment of the present invention;

FIGS. 5A-5C, taken together, is a simplified flowchart illustration of a method for automated bug detection and solution, operative in accordance with a preferred embodiment of the present invention; and

FIGS. 6A through 6I, taken together, is a simplified illustration of an exemplary implementation of the method of FIGS. 5A-5C.

### DETAILED DESCRIPTION OF PREFERRED EMBODIMENTS

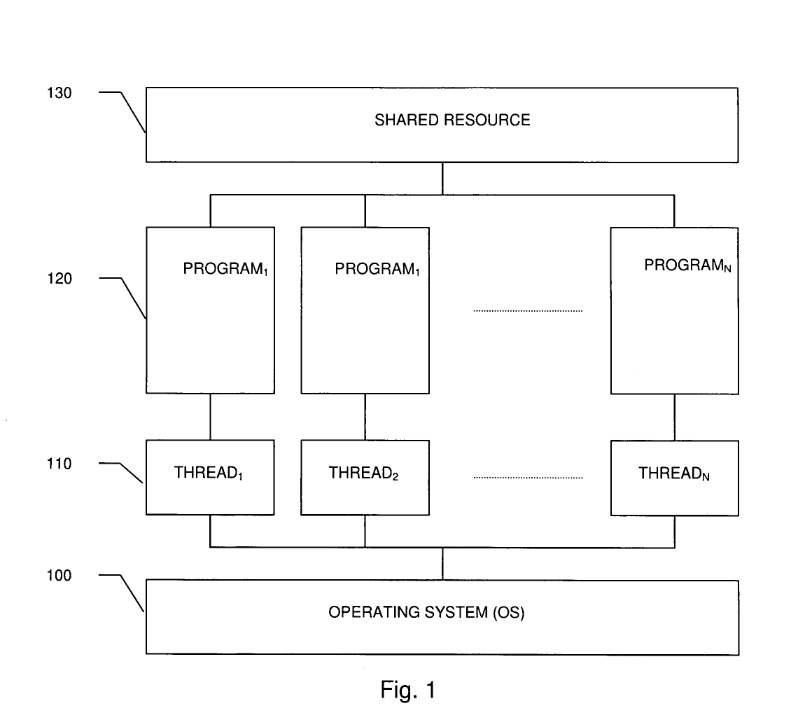

Reference is now made to FIG. 1, which is a simplified illustration of a program execution environment, useful in understanding the present invention. FIG. 1 shows a program execution environment in which an Operating System 100 fixes an association at a particular time between a unique Thread 110 and a unique Program 120. The associations between programs and threads are illustrated through the use of subscripts. Thus, Operating System 100 associates each of Threads 110 with one of the Programs 120 at a particular time for processing, where Thread₁ may be associated with Program₁ at a particular time, and Thread₂ may be associated with Program₂ at the same time or at a different time.

Multiple programs may access a Shared Resource 130 during their execution, such as shared memory. It is typically the responsibility of the software developer to ensure that concurrent access of Shared Resource 130 by programs does not result in a conflict of Shared Resource 130.

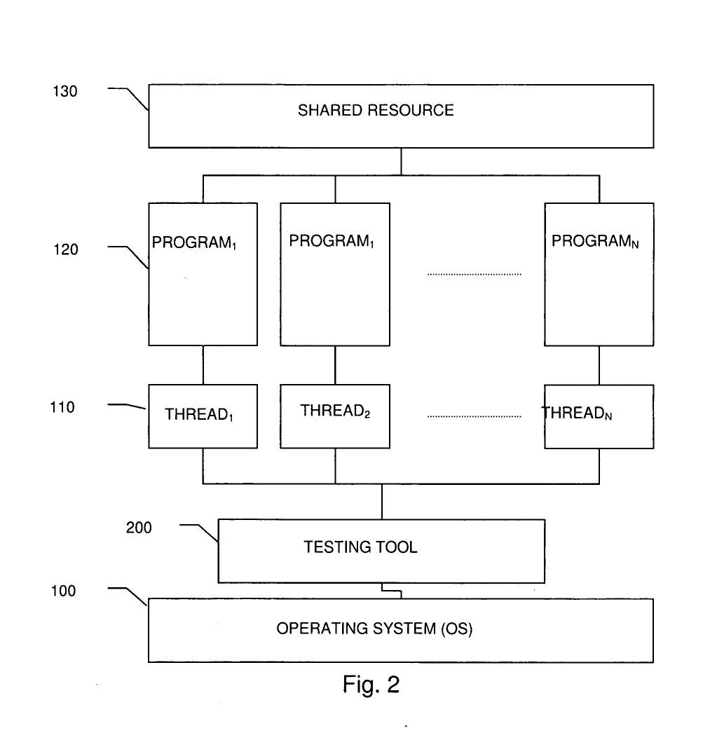

Reference is now made to FIG. 2, which is a simplified illustration of a program testing environment, useful in understanding the present invention. Typically a software developer will test programs in a controlled environment. The introduction of simulated ‘real life’ factors may produce perturbations in the program's execution environment, which in turn may result in program execution errors. To help simulate these perturbations, sophisticated testing tools have been developed, such as the ConTest® tool, described in Edelstein et al. “Multithreaded Java program test generation,” IBM Systems Journal, volume 41, number 1, page 111 (2002). FIG. 2 illustrates the insertion of such a Testing Tool 200 between Operating System 100 and Thread 110. Testing Tool 200 is capable of providing input and/or simulating perturbations that may exist during normal program operation. For example, Testing Tool 200 may halt the execution of Thread 110 or change the sequence in which Thread₁ is activated, by Operating System 100 relative to Thread₂ Testing Tool 200 is also preferably capable of performing a program execution trace to record program execution behavior and output.

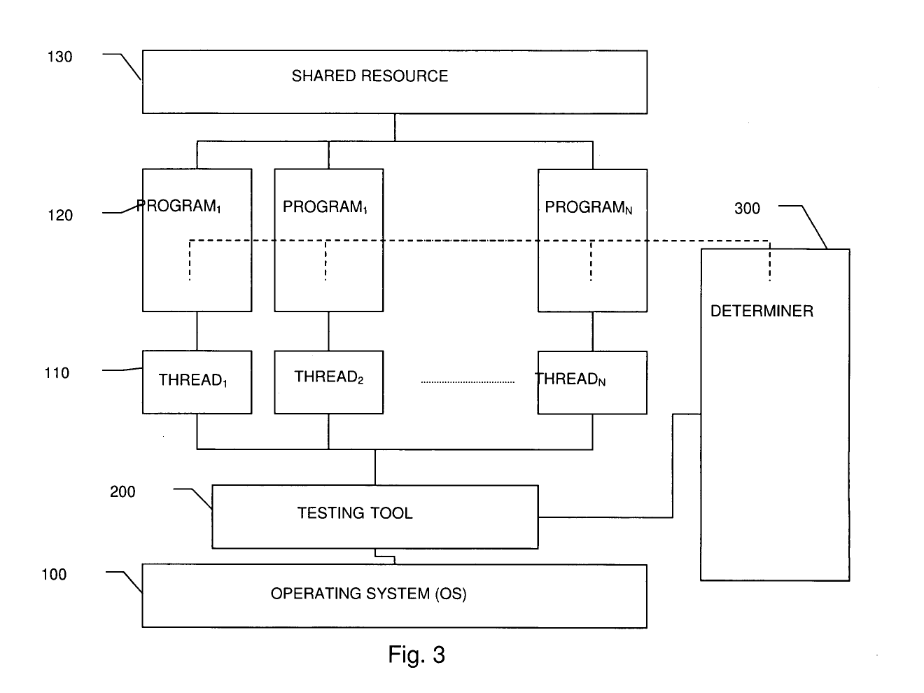

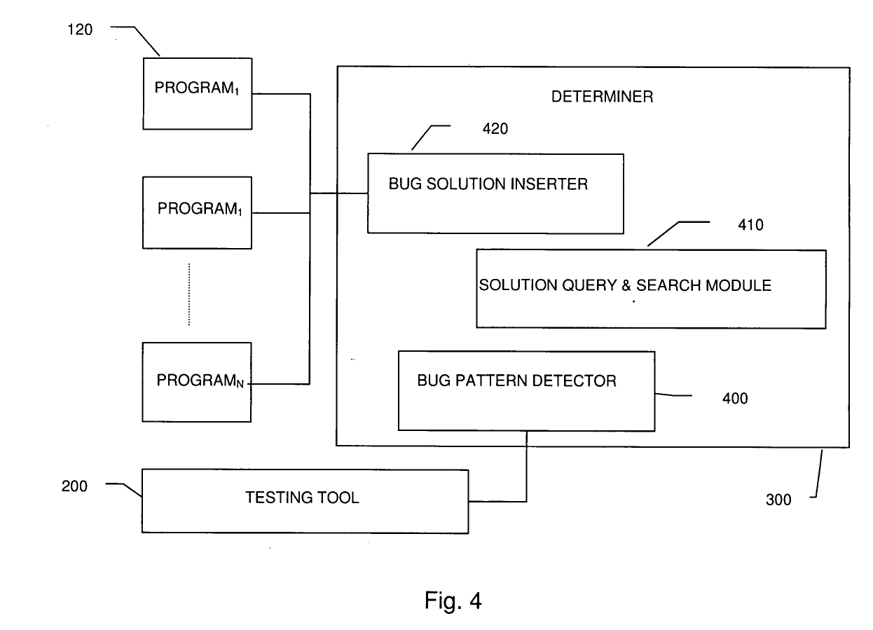

Reference is now made to FIGS. 3 and 4, which are simplified illustrations of an automated bug detection and solution environment, constructed and operative in accordance with a preferred embodiment of the present invention. In FIGS. 3 and 4 a Determiner 300 receives input from Testing Tool 200 and applies modifications to Program 120. As shown in FIG. 4, Determiner 300 typically includes a Bug Pattern Detector 400, a Solution Query & Search Module 410 and a Bug Solution Inserter 420.

Bug Pattern Detector 400 analyzes the program execution behavior and output recorded by Testing Tool 200 to identify bug patterns in Program 120 in accordance with conventional techniques. One such technique is described in Farchi et al. “Concurrent Bug Patterns and How to Test Them,” Proceedings of the 17^{th} International Parallel and Distributed Processing Symposium (IPDPS 2003), 22-26 Apr. 2003, Nice, France, published by the IEEE Computer Society, ISBN 0-7695-1926-1, p. 286, in which one or more bug patterns are predefined. For each bug pattern that is identified, Bug Pattern Detector 400 may propose one or more program modifications as solutions for eliminating the bug pattern that may likewise be predefined and associated with the predefined bug patterns. For example, Bug Pattern Detector 400 may employ Finite State Automata (FSA) to associate one or more solutions to a bug pattern. FSA's are well known in the art for providing probabilistic associations between statistically significant options. The program modifications are preferably “safe” modifications that will not cause a correct program to fail. For example, safe modifications in the context of multi-threaded, concurrent, and distributive applications include synchronization on a non-blocking segment, adding a sleep statement, changing the length of a sleep statement, blocking threads until others do not do anything useful, performing a join on non-blocking threads, putting empty synchronization statements to flash the memory, and waiting for an event that is known will happen.

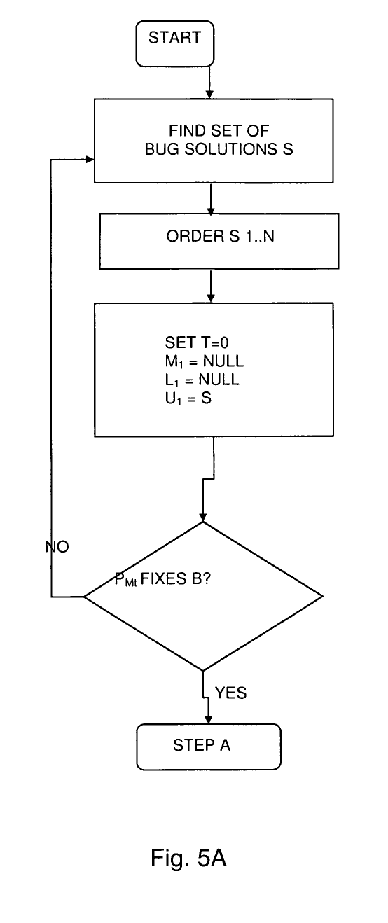

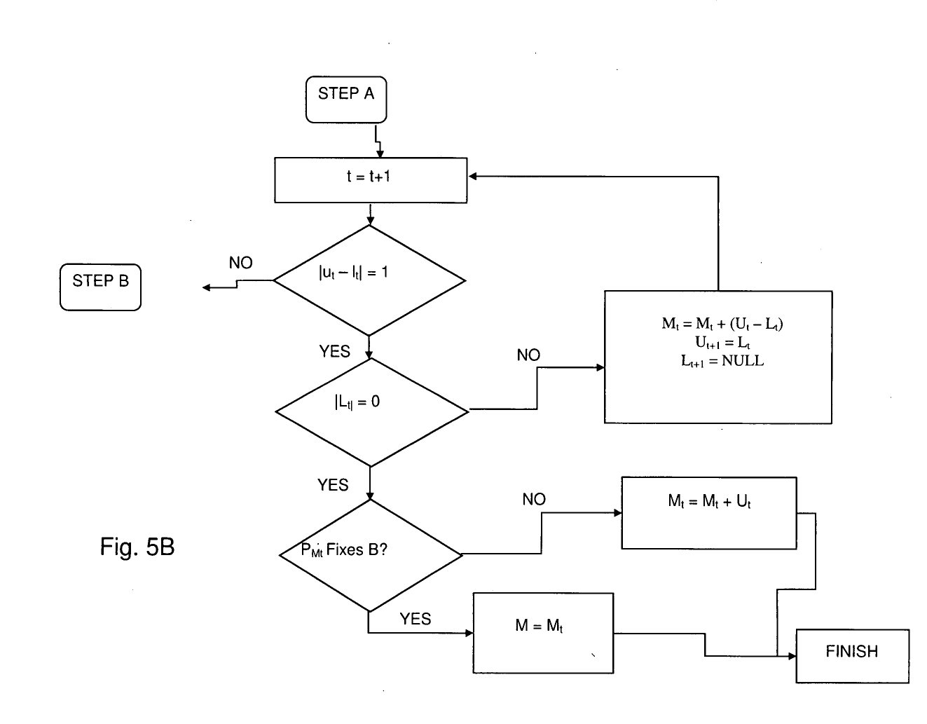

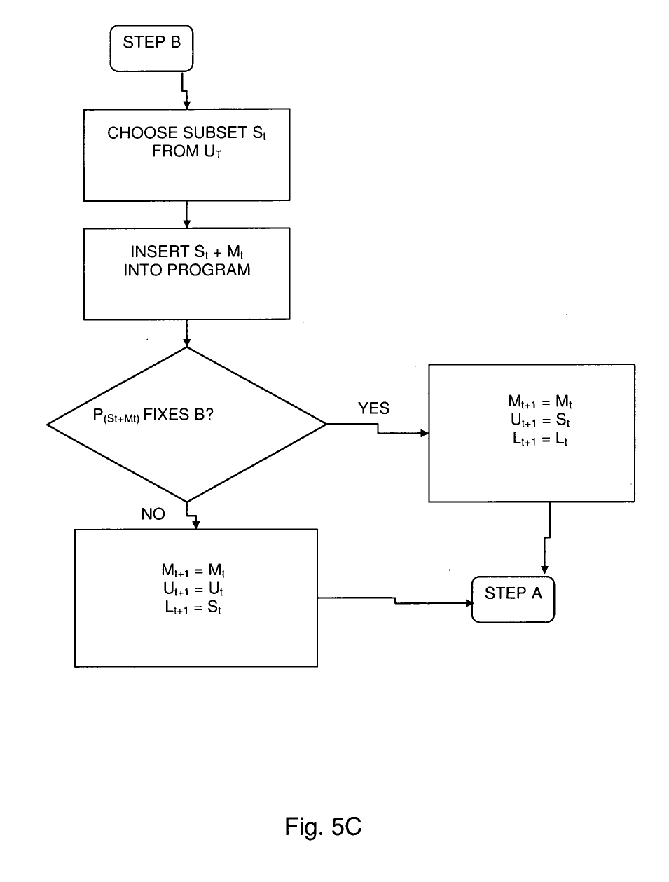

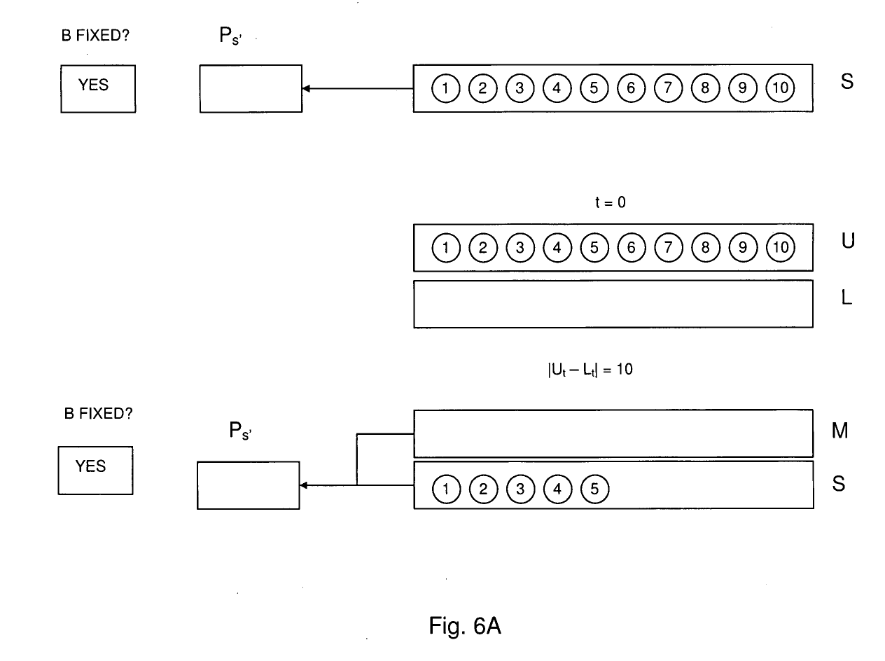

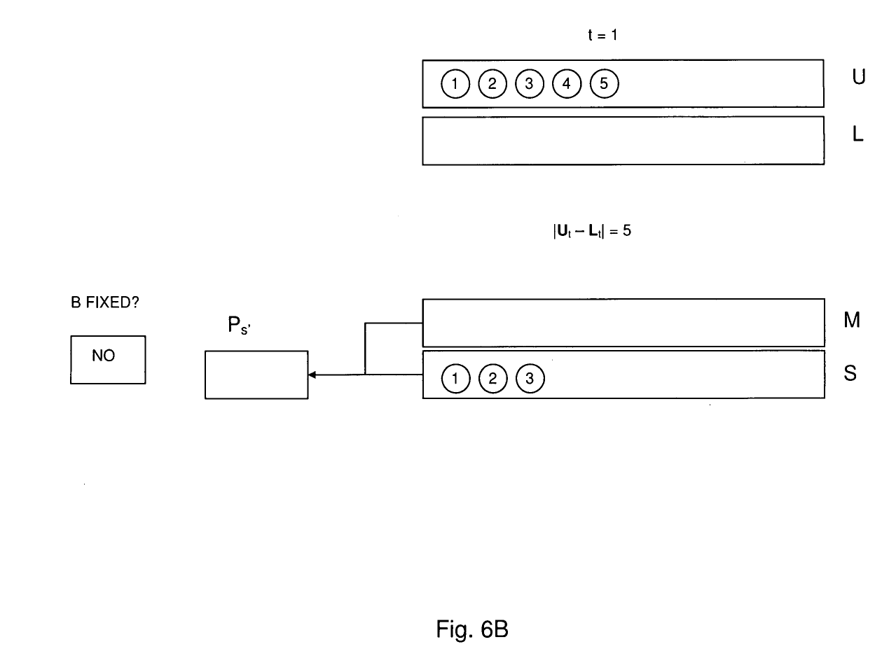

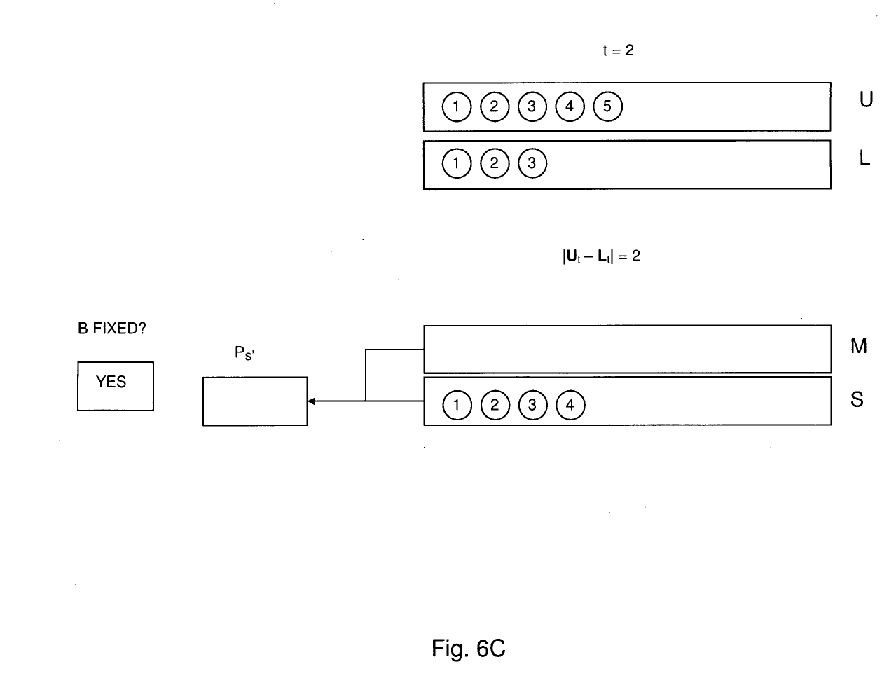

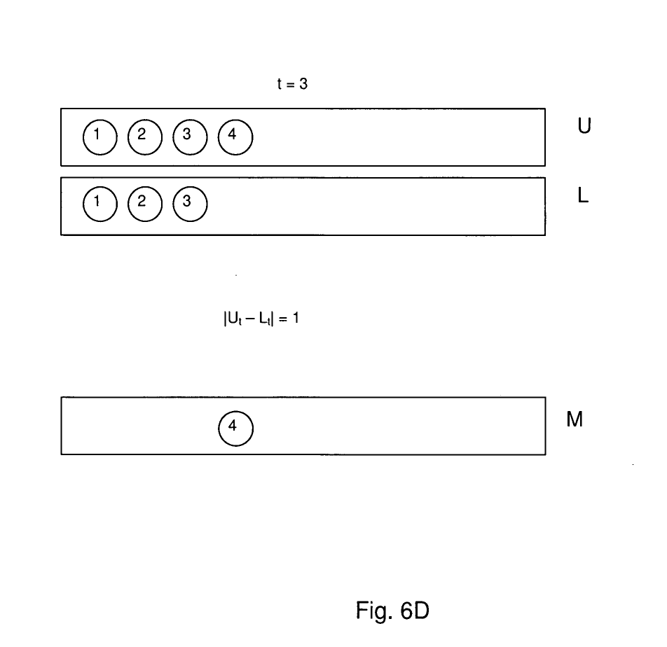

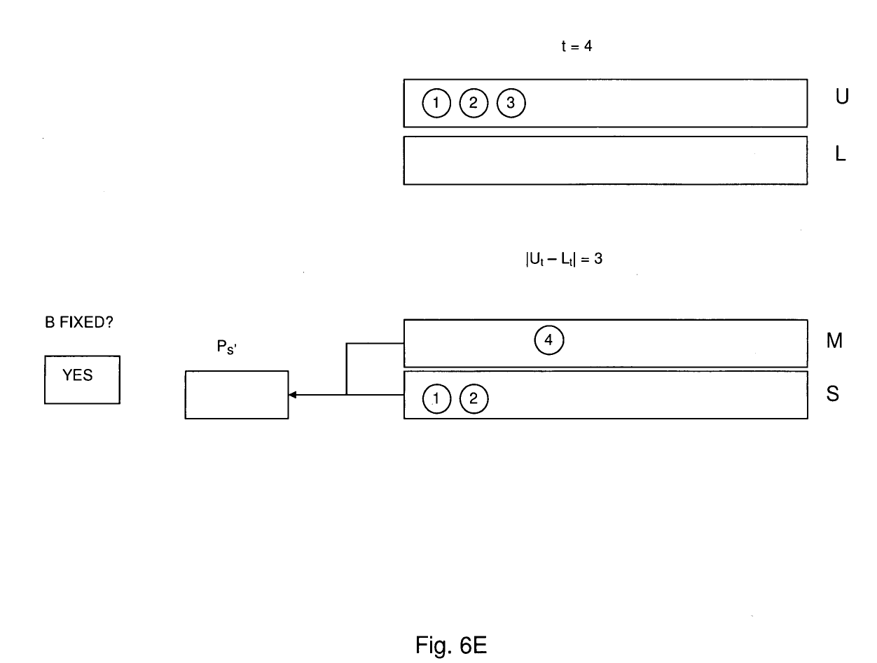

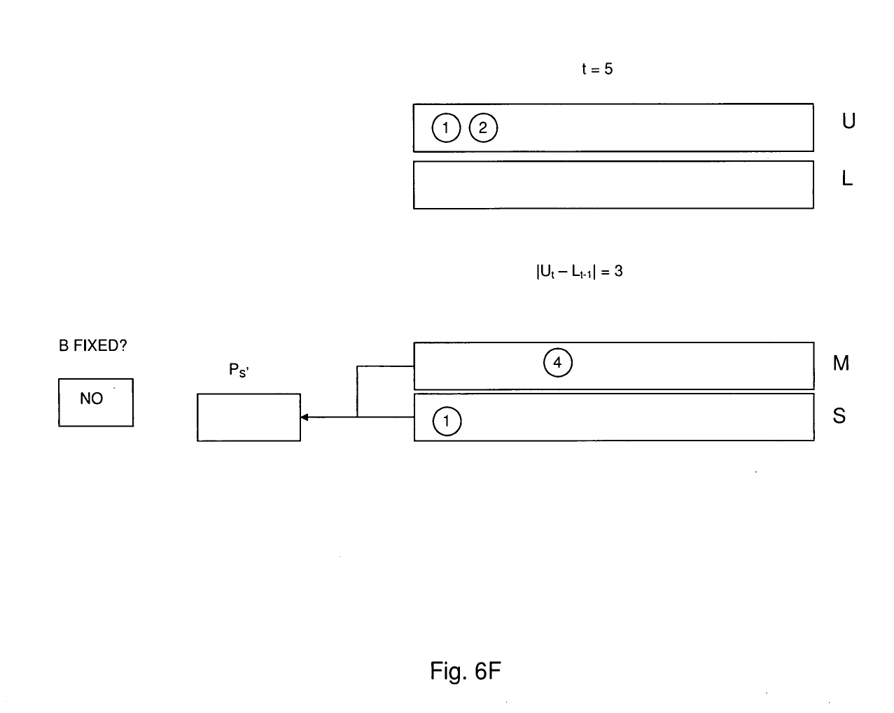

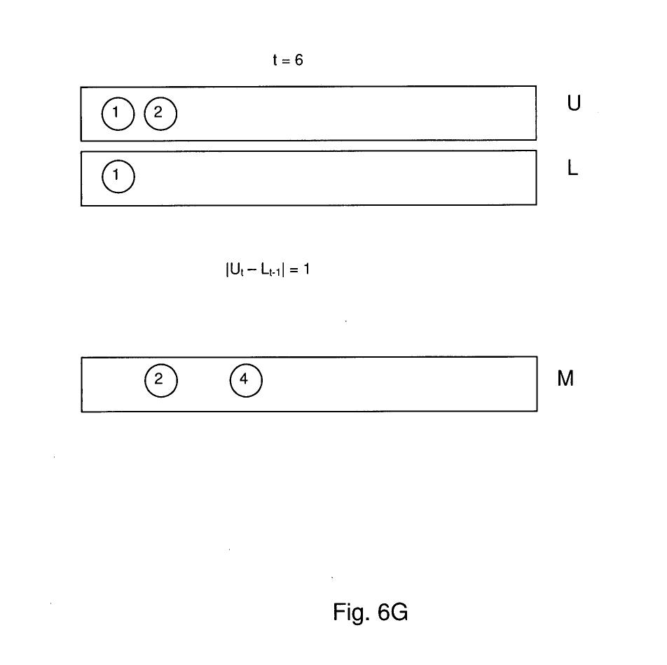

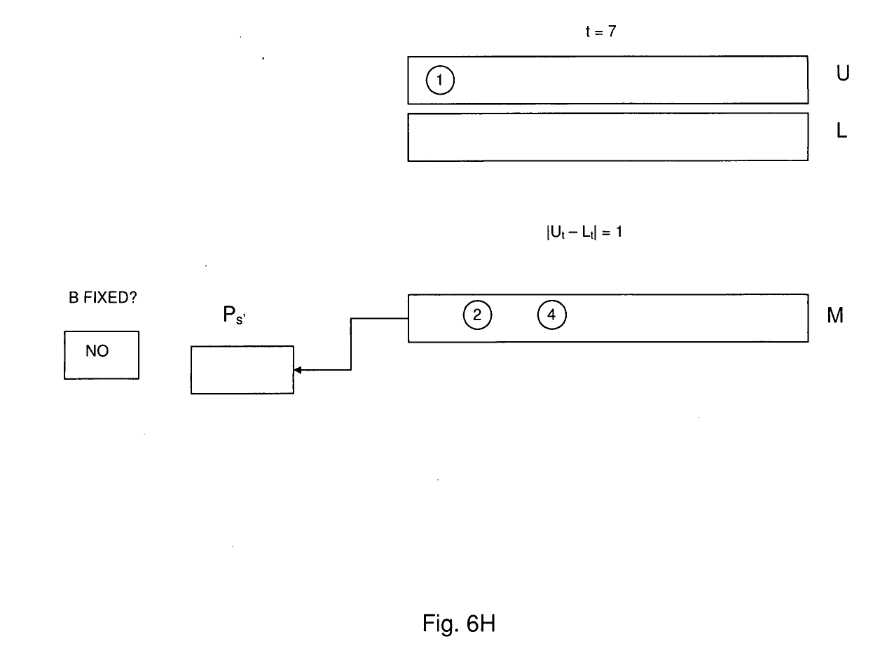

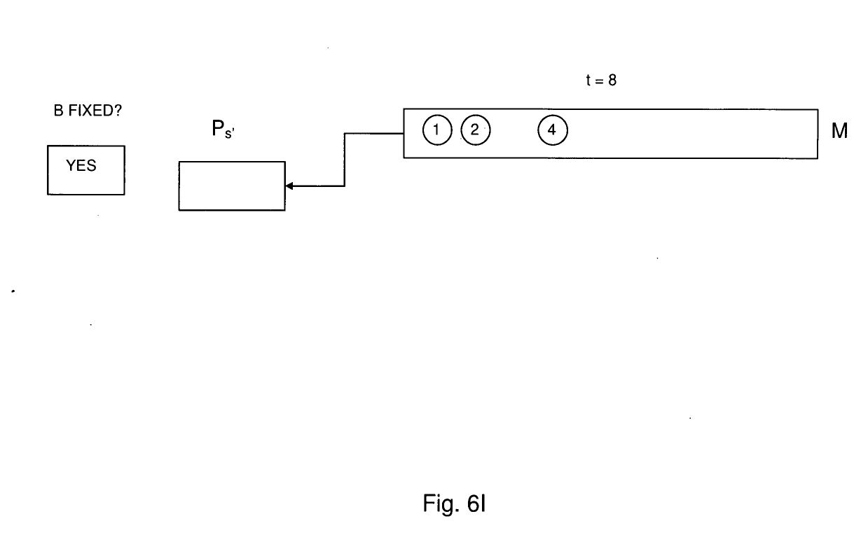

Solution Query & Search Module 410 receives one or more solutions from Bug Pattern Detector 400, and formulates a query that provides a mechanism for performing a search of a solution space to determine sets of solutions. A preferred method of operation of Solution Query & Search Module 410 is described in greater detail hereinbelow with reference to FIGS. 5 and 6.

Bug Solution Inserter 420 modifies Program 120 in accordance with the solution set provided by Solution Query & Search Module 410 in accordance with conventional techniques.

Reference is now made to FIGS. 5A-5C, which, taken together, is a simplified flowchart illustration of a method for automated bug detection and solution, operative in accordance with a preferred embodiment of the present invention. In the method of FIGS. 5A-5C, a program P, such as a multi-threaded program, may be executed a predetermined number of times. Testing Tool 200 may be used to introduce perturbations into the execution environment of program P in accordance with conventional techniques. Bug Pattern Detector 400 identifies one or more bug patterns in P using conventional techniques and provides a set S of candidate bug solutions. For a subset S′ of S, P_{S′} denotes program P modified according to the solutions in set S′. Solution Query & Search Module 410 employs Bug Solution Inserter 420 to insert S into program P to create program P_{S}. Solution Query & Search Module 410 then executes program P_{S} a predetermined number of times, such as with Testing Tool 200, to test the efficacy of S, the implemented solutions. Should the solution not satisfy a predefined set Q of requirements, such as the elimination of previously detected bugs B, a different set S is preferably defined, beginning an iterative process noted by the letter t hereinbelow, by which a local optimal subset M of S is found.

Set M, initially empty, may be defined to include solutions in S identified as Required Solutions as is explained hereinbelow. At iteration t, Mₜ will preferably include all known Required Solutions as of this iteration. Sets Lₜ and Uₜ may also be defined to include Non-Required Solutions. Lₜ and Uₜ are subsets of S−Mₜ, such that Mₜ+Lₜ does not eliminate the bug B but Mₜ+Uₜ does. Initially, set L₀ is empty and set U₀ includes all of S. Preferably, U₀ is arbitrarily ordered to facilitate a methodology by which subsequent subsets are extracted from U. The following may then be performed:

At each iteration t:
If |Uₜ−Lₜ|=1, then
   If |Lₜ|=0
      Should the implemented solutions of Mₜ (P_{Mt}) satisfy a predefined set Q of requirements, such as the elimination of previously detected bugs B, set M=Mₜ
      Should the solutions of Mₜ (P_{Mt}) not satisfy Q, set M=Mₜ together with the sole element of Uₜ.
      In both cases, the current iteration is the final iteration.
   Otherwise, set Mₜ₊₁=Mₜ+(Uₜ−Lₜ); Lₜ₊₁=empty set; Uₜ₊₁=Lₜ, and proceed to the next iteration.
Otherwise, select a set Sₜ such that Lₜ is a proper subset of Sₜ and Sₜ is a proper subset of Uₜ, and implements the solutions of Sₜ.
   Should the implemented solutions of Sₜ together with Mₜ (P_{St+Mt}) satisfy Q of requirements, set Mₜ₊₁=Mₜ; Lₜ₊₁=Lₜ; Uₜ₊₁=Sₜ, and proceed to the next iteration.
   Should the solutions of Sₜ together with Mₜ (P_{St+Mt}) not satisfy Q, set Mₜ₊₁=Mₜ; Lₜ₊₁=Sₜ; Uₜ₊₁=Uₜ, and proceed to the next iteration.

Alternatively, the iterative process may terminate after a predefined number of iterations, or once |Mₜ+Uₜ| is smaller than a predefined size, in which cases M is set to be Mₜ+Uₜ.

Sₜ may be selected at each iteration as follows. The set S may be ordered in an arbitrary way, where S={s₀, s₁, . . . , sₐ₋₁}. Let [k] denote the set {s₀, . . . , sₖ₋₁} for k>0 and the empty set for k=0. According to the method described above, L₀=[0] and U₀=[n]. At each iteration step t, if Lₜ=[a] and Uₜ=[b], Sₜ may be set equal to (b−a)/2, rounded upwards or downwards if necessary. It may be seen that at each step either Lₜ or Uₜ is left as is, or either is set equal to Sₜ. Therefore, if the selection of Sₜ at iteration t is carried out as described above, at iteration t+1 both Lₜ and Uₜ are of the form [k], and the selection of Sₜ₊₁ can be carried out as described herein.

Reference is now made to FIGS. 6A through 6I which, taken together, is a simplified illustration of an exemplary implementation of the method of FIGS. 5A-5C. At the initialization time step, t=0, Solution Query & Search Module 410 labels the complete set of 10 solutions S, generated by Bug Pattern Detector 400, as candidate solutions and orders them as candidate solution₁ through candidate solutions in set S. Solution Query & Search Module 410 further initializes sets M₀ and L₀ as empty sets, and U₀ equal to S. Solution Query & Search Module 410 employs Bug Solution Inserter 420 to insert S into program P to create program P_{S}. Solution Query & Search Module 410 then executes Testing Tool 200 to determine if B is indeed resolved. In the present example S is determined to resolve B.

An iterative process then begins as follows. Solution Query & Search Module 410 tests the difference between the sizes of U₀ and L₀, and since |U₀−L₀| in this example is equal to 10, Solution Query & Search Module 410 places half of U₀ in subset S₀, i.e. candidate solution₁ through candidate solution₅, and employs Bug Solution Inserter 420 to insert S₀+M₀ into program P to create program P_{S0}. Solution Query & Search Module 410 then executes Testing Tool 200 to determine if program P_{S0} retains bug B. In the example shown P_{S0} does not retain bug B. Since the set of candidate solution₁ through candidate solution₅ fixes bug B, the remaining candidate solutions, candidate solution₆ through candidate solution₁₀, are known not to be necessary for the successful execution of program P. Solution Query & Search Module 410 sets U₁ to be equal to S₀, the set of candidate solution₁ through candidate solution₅; L₁ to L₀, the empty set; and M₁ to M₀, the empty set.

The iterative process continues as before to determine which of the other candidate solutions are required to fix bug B. The iterator t is incremented to 1, Solution Query & Search Module 410 determines that the difference between the sizes of U₁ and L₁ is 5, and half of U₁ is placed in subset S₁, i.e. candidate solution₁ through candidate solution₃. This is so because L₁ is empty, although in general Lₖ is combined with half of (Uₖ−Lₖ). Bug Solution Inserter 420 inserts S₁+M₁ into program P to create program Ps₁. Solution Query & Search Module 410 then executes Testing Tool 200 to determine if program Ps₁ retains bug B. In the example shown, program Ps₁ retains bug B. At this point U₂ is set equal to U₁, which includes candidate solution₁ through candidate solution₅, L₂ is set equal to S₁, which includes candidate solution₁ through candidate solution₃, and M₂ is set equal to M₁, the empty set.

Iterator t is incremented to 2, and Solution Query & Search Module 410 determines that the difference between the sizes of U₂ and L₂ is greater than 1, and chooses a new subset S₂ from U₂, combining L₂ with half of the elements from U₂−L₂. In this example, S₂ is the set of candidate solution₁ through candidate solution₄ Solution Query & Search Module 410 employs Bug Solution Inserter 420 to insert S₂+M₂ into program P to create program Ps₂. Testing Tool 200 is then executed and determines that S₂ indeed fixes bug B. Hence U₃ is set equal to S₂, which includes the set of candidate solution₁ through candidate solution₄; L₃ is set equal to L₂, which includes the set of candidate solution₁ through candidate solution₃; and M₃ is set equal to M₂, the empty set.

The iterator t is incremented to 3, Solution & Search Module 410 determines that the difference between the sizes of U₃ and L₃ is 1. The sole solution in U₃−L₃, candidate solution₄, is labeled as a required solution, and joins set M₄, the subset of required solutions. U₄ is set equal to L₃, and L₄ is set equal to the empty set. Since L₃ is non-empty, the next iteration may be carried out.

Iterator t is incremented to 4, and since |U₄−L₄|>1 in this example, Solution Query & Search Module 410 chooses a new subset S₄ from U₄. In this example, S₄ is the set including candidate solution₁ and candidate solution₂. Solution Query & Search Module 410 employs Bug Solution Inserter 420 to insert S₄+M₄ into program P to create program Ps₄. Testing Tool 200 is then executed and determines that S₄+M₄ indeed fixes bug B. U₅ is set equal to S₄, which includes the set including candidate solution₁ and candidate solution₂; L₅ is set equal to L₄, the empty set; and M₅ is set equal to M₄, which includes candidate solution₄.

The iterator t is incremented to 5, and since |U₅−L₅|>1 in this example, a subset of U₅ is placed in subset S₅, i.e. candidate solution₁ Bug Solution Inserter 420 inserts S₅+M₅ into program P to create program Ps₅. Solution Query & Search Module 410 then executes Testing Tool 200 to determine if program Ps₅ retains bug B. In the example shown Ps₅ does retain bug B. At this point U₆ is set equal to U₅, which includes the set of candidate solution₁ through candidate solution₂; L₆ is set equal to S₅, which includes candidate solution₁; and M₆ is set equal to M₅, which includes candidate solution₄.

Iterator t is incremented to 6. At this stage a single candidate solution, the difference between U₆ and L₆ has been isolated. This solution, candidate solution₂, is labeled as a required solution, and joins M₆ to form the set M₇, the subset of required solutions. Next U₇ is set equal to L₆, which includes candidate solution₁; L₇ is set equal to the empty set.

Iterator t is incremented to 7, Solution & Search Module 410 determines that |U₇−L₇|=1, and also that |L₇|=0. Solution Query & Search Module 410 employs Bug Solution Inserter 420 to insert M₇ into program P to create program P_{S8}. Testing Tool 200 is then executed and determines that M₈ does not fix bug B. Thus, the sole element of U₈ is necessary for bug removal. This solution, candidate solution, is labeled as a required solution, and is joined to the set M₈ to obtain M, the set of required solutions that may then be used to automatically modify P or that may be suggested as a course of action to a human programmer for modifying P.

In one exemplary scenario of the present invention, Bug Pattern Detector 400 proposes to modify a multi-threaded computer program with the insertion of a synchronization point in each thread. For example, a part of a program P is defined to increment a shared variable x using two threads. The requirement Q requires that P read the value of x=2 after the threads complete. Sample pseudo-code appears as follows:

```
int x=0;
Main( )
{
  a1 = new A1( );
  a2 = new A2( );
  a1.Run( );
  a2.Run( );
  // other part of program
  ...
  join (a1); //pass this point only after a1 completes
  join (a2); //pass this point only after a2 completes
  print x; //or some other use of x; expect value of 2
}
class A1 extends Thread
{
    public Run( )
    {
      DoIncrement( );
    }
    public void DoIncrement( )
    {
      x++;
    }
}
class A2 extends Thread
{
    public Run( )
    {
      DoIncrement( );
    }
    public void DoIncrement( )
    {
      x++;
    }
}
```

Solution Query & Search Module 410 executes Testing Tool 200 on program P and determines that sometimes values of x used are smaller than 2, and thus defines bug B. Next, Solution Query & Search Module 410 utilizes Bug Pattern Detector 400 to propose candidate solutions. In this example, Bug Pattern Detector 400 proposes multiple solutions in the rest of the program in addition to two synchronizations in the DoIncrement methods of classes A1 and A2, e.g.:

```
public void DoIncrement( )
{
  synchronized
  {
  x++;
  }
}
```

Thus, the solution space is composed of multiple candidate solutions defining set S, including the synchronization of A1.DoIncrement( ), labeled candidate solutions, and the synchronization of A2.DoIncrement( ), labeled candidate solution.

Solution Query & Search Module 410 performs the method described hereinabove and isolates candidate solutionᵢ and candidate solutionⱼ as fixing bug B. Thus, it is known that candidate solutionᵢ and candidate solutionⱼ together fix bug B, and that all the other candidate solutions are not necessary for the successful execution of program P and may be removed from set S.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1. A system for automated bug detection and solution comprising:
a testing tool operative to record execution behavior and output of a computer program; and
a determiner comprising:
a bug pattern detector operative to analyze said program execution behavior and output to identify a bug pattern therein and propose at least one program modification for effecting a solution to eliminate said bug pattern;
a solution query & search module operative to iteratively define a plurality of subsets of said proposed solutions in accordance with a predefined selection criterion; and
a bug solution inserter operative to iteratively apply said subsets of proposed solutions to said program, thereby creating a plurality of differently-modified versions of said program,
wherein any of said testing tool, said bug pattern detector, said solution query & search module, and said a bug solution inserter are embodied in a computer program on a computer-readable medium,
and wherein said determiner is configured to:
a) select a first candidate solution subset from a set of solutions for a computer program that produces an error when executed, wherein each of said solutions represents a different proposed modification of said program for eliminating said execution error;
b) apply said first candidate solution subset to said computer program, thereby creating a first version of said program;
c) select a second candidate solution subset from said set of solutions;
d) apply said second candidate solution subset to said program, thereby creating a second version of said program;
e) execute said program versions to determine whether either of said executed program versions produces said error; and
f) add the difference between said first and second candidate solution subsets to a required solution subset where:
one of said executed program versions produces said error, and
the other of said executed program versions does not produce said error,
wherein said determiner is configured to perform any of a)-f) a plurality of times for different candidate solution subsets until applying said required solution subset to said computer program creates a version of said program that when executed does not produce said error.

2. A system according to claim 1 wherein said testing tool is operative to introduce perturbations into said program.

3. A system according to claim 1 wherein said bug pattern is predefined.

4. A system according to claim 1 wherein said solution is in predefined association with said predefined bug pattern.

5. A system according to claim 1 wherein said solution query & search module is operative to identify any of said solution subsets that satisfies a predefined solution criterion.

6. A system according to claim 5 wherein said predefined solution criterion is whether any of said subsets has the fewest members among all of said subsets that together eliminate said bug pattern.

7. A system according to claim 5 wherein said predefined solution criterion is whether, after a predefined number of iterations, any of said subsets that have been applied to said program has the fewest members among all of said subsets that together eliminate said bug pattern.

8. A system according to claim 5 wherein said predefined solution criterion is whether any of said subsets has a member population smaller than a predefined size that together eliminate said bug pattern.

9.-13. (canceled)

14. A computer program embodied on a computer-readable medium, the computer program comprising:
a first code segment operative to select a first candidate solution subset from a set of solutions for a computer program that produces an error when executed, wherein each of said solutions represents a different proposed modification of said program for eliminating said execution error;
a second code segment operative to apply said first candidate solution subset to said computer program, thereby creating a first version of said program;
a third code segment operative to select a second candidate solution subset from said set of solutions;
a fourth code segment operative to apply said second candidate solution subset to said program, thereby creating a second version of said program;
a fifth code segment operative to execute said program versions to determine whether either of said executed program versions produces said error; and
a sixth code segment operative to add the difference between said first and second candidate solution subsets to a required solution subset where:
one of said executed program versions produces said error, and
the other of said executed program versions does not produce said error,
wherein any of said code segments may be executed a plurality of times for different candidate solution subsets until applying said required solution subset to said computer program creates a version of said program that when executed does not produce said error.
